(19) United States
(12) Patent Application Publication
(10) Pub. No.: US 2009/0136014 A1
(43) Pub. Date: May 28, 2009

(54) Method for Determining the On-Hold Status in a Call

(75) Inventors: Jason P. Bigue, Toronto (CA); Shai Berger, Tronto (CA)

Correspondence Address: CARL M. NAPOLITANO, PH.D.;ALLEN, DYER, DOPPELT, MILBRATH & GILCHRIST, P.A., 255 SOUTH ORANGE AVE., SUITE 1401, P.O. BOX 3791, ORLANDO, FL, 32802-3791, US

(73) Assignee: FonCloud, Inc., Toronto (CA)

(21) Appl. No.: 12/276,621

(22) Filed: Nov. 24, 2008

Related U.S. Application Data
(60) Provisional application No. 60/989,908, filed on Nov. 23, 2007.

(51) Int. Cl. H04M 3/42; H04M 3/00

(52) U.S. Cl. 379/207.02; 379/266.01

(57) ABSTRACT

A system and method is provided for detecting a hold status in a transaction between a waiting party and a queuing party. The system is adapted to use a preexisting cue profile database containing cue profile for a queuing party. A preexisting cue profile may be used for detecting a hold status in a call between a waiting party and a queuing party. The cue profile of the queuing party may include audio cues, text cues, and cue metadata. The transaction may be a telephone based, mobile-phone based, or internet based.

### CROSS REFERENCE TO RELATED APPLICATIONS

This application claims priority from U.S. Provisional Patent Application Ser. No. 60/989,908 filed Nov. 23, 2007, the disclosure of which is herein incorporated by reference in its entirety.

### FIELD OF INVENTION

Various embodiments related to telephone-based or internet-based call transactions are presented.

### BACKGROUND

In telephone-based or internet-based communication, data, voice or sound (or a combination) is exchanged between parties on a call (typically two parties). Traditionally, businesses have utilized people to participate in telephone-based transactions with their clients. However, recently there are an increasing number of transactions that use automated services and do not engage a person until a certain stage of the call. The embodiments presented herein, relate to such transactions.

### SUMMARY

The present embodiments provides in one aspect, a system for detecting a hold status in a transaction between a waiting party and a queuing party, said system comprising a device adapted to use a preexisting cue profile database containing cue profile for at least one queuing party.

In another aspect, the present embodiments provide for the use of a preexisting cue profile for detecting a hold status in a call between a waiting party and a queuing party.

In another aspect, the present embodiments provide a method for detecting a hold status in a transaction between a waiting party and a queuing party, said method comprising using a preexisting cue profile database containing cue profile for at least one queuing party.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1A is an illustration of “on hold” and “Live” states in a call in which the human at the waiting party is “on hold”.

FIG. 1B is an illustration of the “on hold” and “Live” states in a call in which the human at the waiting party is connected “Live” to a human at the queuing party.

FIG. 2 is an illustration of an exemplary cue profile from a cue profile database.

FIG. 3A is an illustration of an exemplary call timeline of a call involving an on-hold state and a live state.

FIG. 3B is an illustration of an exemplary training call in creating an audio cue profile for a queuing party.

FIG. 3C is an illustration of an exemplary testing call in testing an exemplary audio cue profile for a queuing party.

FIG. 3D is an illustration of an exemplary call flow in creating an audio cue profile for a queuing party.

FIG. 4A is an illustration of an exemplary testing of audio clips with two channels of processing.

FIG. 4B is an illustration of an exemplary testing of audio clips in which both channels are used for real-time positive and negative testing.

FIG. 5 is an illustration of an exemplary verbal challenge.

### DETAILED DESCRIPTION

The embodiments and implementations described here are only exemplary. It will be appreciated by those skilled in the art that these embodiments may be practiced without certain specific details. In some instances however, certain obvious details have been eliminated to avoid obscuring inventive aspects the embodiments.

Embodiments presented herein relate to telephone-based (land or mobile) and internet-based call transactions. The words “transaction” and “call” are used throughout this application to indicate any type of telephone-based or internet based communication. It is also envisioned that such transactions could be made with a combination of telephone and internet-connected device.

In all such transactions, the client (normally, but not necessarily, the dialing party) is the waiting party or on-hold party who interacts with an automated telephone-based service (normally, but not necessarily, the receiver of the call) which is the queuing party or holding party (different from the on-hold party). The terms “waiting party” and “queuing party” are used throughout this application to indicate these parties, however, it could be appreciated by those skilled in the art that the scope of the embodiments given herein applies to any two parties engaged in such transactions.

During a typical transaction between a waiting party and a queuing party, the waiting party needs to take certain measures like pressing different buttons or saying certain phrases to proceed to different levels of the transaction. In addition, the waiting party may have to wait “on hold” for a duration, before being able to talk to an actual person. Any combination of the two is possible and is addressed in the embodiments given herein.

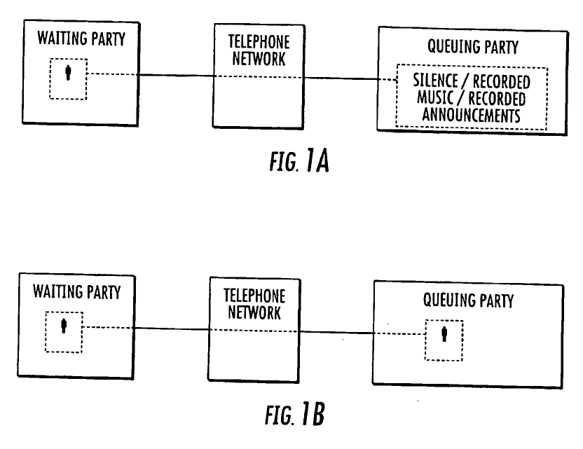

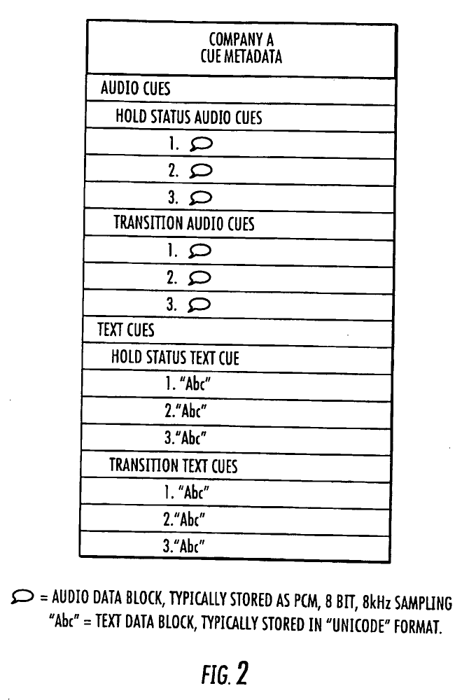

To understand one example, as shown in FIG. 1, two states during a transaction are considered. The state during which a waiting party is dealing with the automated system and has not reached an actual person is called the “on-hold state”. The state during which the waiting party is talking to an actual person is called the “live state”. Accordingly, the phrase “hold status” is used to refer to either the on-hold state or the live state, depending on whether or not the waiting party is on hold or talking to an actual person, respectively.

It is desirable for the waiting party to find out when the hold status changes from an on-hold state to a live state by a method other than constantly listening and paying attention. Accordingly, different embodiments presented herein address the issue of “hold status detection”.

A “cue profile” of a company, in this disclosure, is referred to as all the information available about the queuing party hold status. In some embodiments presented herein, the preexisting cue profiles of different queuing parties are used to determine the hold status.

In some embodiments, the cue profile may contain the hold status “audio cues” which are used to detect the hold status for a particular queuing party. Audio cues are any audible cues that could bear information about the hold status. For instance, music, pre-recorded voice, silence, or any combination thereof could indicate an on-hold state. On the other hand, the voice of an actual person could indicate a live state. The event of transition from an on-hold state to a live state could be very subtle. For instance, the transition form a recorded message to a live agent speaking may not be accompanied by any distinguished audio message like a standard greeting. Nevertheless there are audio cues indicating the transition from an on-hold state to a live state. Such audio cues are called “transition audio cues”.

In some embodiments, certain preexisting data about a queuing party is used to determine the hold status. Such preexisting data is referred as “cue metadata”. For example, the cue metadata may indicate the sensitivity required for each cue in order to dependably identify it in the audio stream while avoiding false-positives. In these particular embodiments, combinations of hold status audio cues in combination with cue metadata are referred to as the cue profile.

Some embodiments described herein relate to finding the cue profile of a particular queuing party. In certain embodiments, the queuing party itself is used, at least partially, to provide cue metadata to create a cue profile. However, in other embodiments, the cooperation of the queuing party is not necessary.

In some embodiments, “dial-in profiling” is used to create a cue profile of a queuing party accessible through PSTN. The method used in these embodiments is an ordinary telephone connection as used by a typical waiting party.

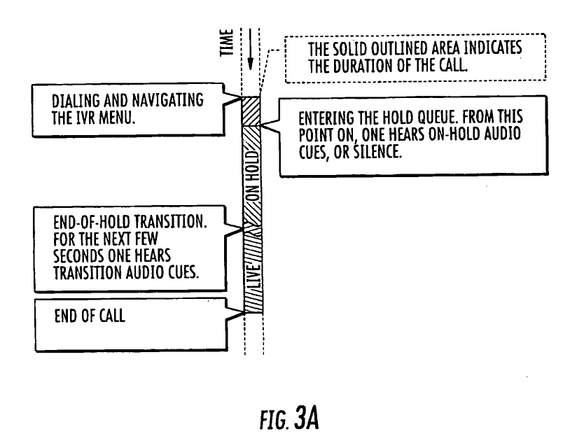

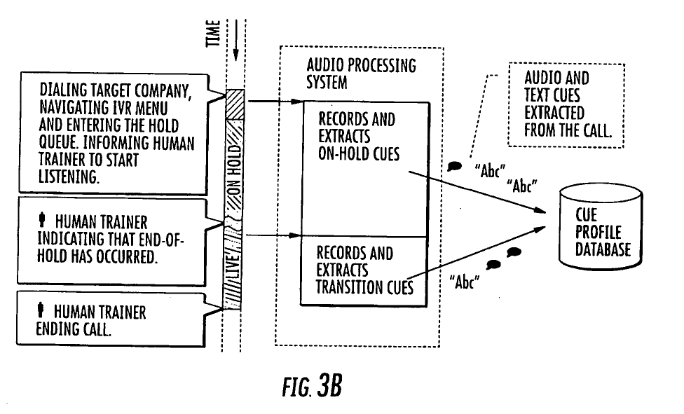

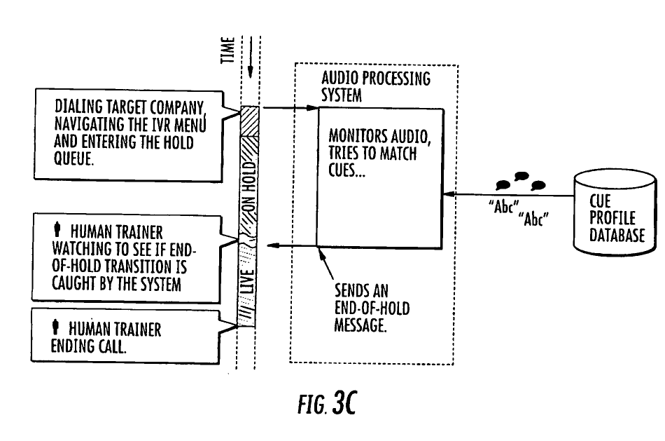

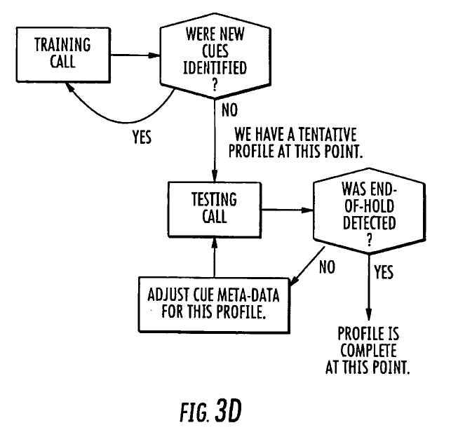

Dial-in profiling is an iterative process that is done in order to figure out the hold status of a queuing party. FIGS. 3A, 3B, 3C, and 3D are exemplary illustrations of dial-in profiling according to one embodiment. Seen in these figures are different layers and branches of hold status. Once the profile of a certain queuing party is configured, it is entered into a cue profile database as seen in the figures.

In certain cases, dial-in profiling, as described herein, could be the only means for creating a cue profile of a queuing party. In addition, dial-in profiling, according to some embodiments, could also be used to update, expand, or edit a previously created cue profile.

Audio cues could be stored in a standardized format (for example, MP3) and are of fixed time length, for instance two seconds. Another type of cue used in some embodiments is a text cue, which is stored in a standard format (for example ASCII) and is of fixed length (for example two syllables).

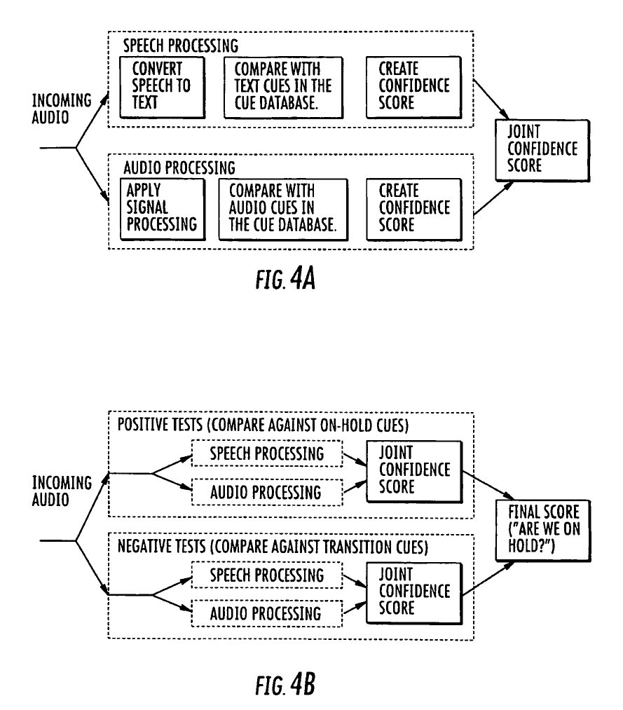

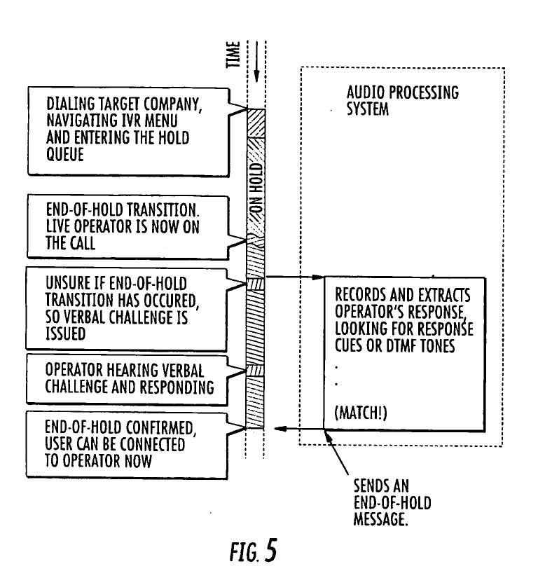

In some embodiments these two cues are used create a confidence score. Shown in FIGS. 4A and 4B, certain sections of audio are extracted from a call. These sections, called audio samples, are then compared with audio cues of a given queuing party in what is called an audio test, to create a confidence score. A speech recognition engine in an audio processing system is then used to process the audio samples. The output of the speech recognition engine is compared with text cues to create a text-based confidence score in what is called a text test. The results of audio tests and text tests are then combined to create a final confidence score. The final confidence score is used to determine the hold status. The audio tests and text tests may happen in parallel or they may happen sequentially.

In one embodiment related to the case when the audio cues are not sufficient to detect the hold status, a verbal challenge is issued to the queuing party. A verbal challenge consists of a prerecorded message which is asked of the queuing party at specific instances. For example, one verbal challenge may be “is this a live person?” After a verbal challenge has been issued, a speech recognition engine determines whether there is any response from a live person to the verbal challenge. Based on this, a judgment is made as to the hold status. FIG. 5 is an illustration showing the function of the verbal challenge in the system.

Verbal challenges can also make use of DTMF tones. For example, the challenge could be “press 1 if you are a real human”. In this case, the audio processing system will be searching for the DTMF tones instead of an audio cue. If the queuing party is in a live state, it may send an unprompted DTMF tone down the line in order to send preemptive notification of the end-of-hold transition. In an order to handle this case the audio system is always listening to and detecting DTMF tones.

A typical apparatus built in accordance with some embodiments presented herein, is referred to as a “hold detection system” and it could comprise, inter alia, some of the following components:
Audio processing system—for extracting audio clips from the phone call and preparing them for analysis by either the speech recognition engine or the audio pattern matching component.
Speech recognition engine—for taking an audio sample and converting human speech to text.
Audio pattern matching component—for taking an audio sample and comparing it to the relevant audio cues contained in a cue database.
Cue processor component—for taking results from the speech recognition engine and audio pattern matching component and computing a confidence score for the hold status.
Audio playback component—for playing pre-recorded audio for the verbal challenge.
Cue profile database—for containing the cue profiles for one or more companies.

It should be noted that any number of the components mentioned above could be integrated into a single component, device. And it should be noted that any device capable of using preexisting cue profile database to determine the hold status in a call or transaction falls within the scope of the embodiments presented herein.

The embodiments presented herein address, inter alia, the following difficulties:

Lack of formal signaling of the hold status in the telephone network.

Hold status cues vary widely between companies.

Hold status cues for a given company can change over time.

Cues may not be sufficient to determine the end-of-hold transition.

Companies do not make available any information about their cues.

It will be obvious to those skilled in the art that one may be able to envision alternative embodiments without departing from the scope and spirit of the embodiments presented herein.

As will be apparent to those skilled in the art, various modifications and adaptations of the structure described above are possible without departing from the present invention, the scope of which is defined in the appended claims.

That which is claimed is:

1. A system for detecting a hold status in a transaction between a waiting party and a queuing party, said system comprising a device adapted to use a preexisting cue profile database containing cue profile for at least one queuing party.

2. The system of claim 1, wherein the cue profile of the queuing party comprises at least one of audio cues, text cues, and cue metadata.

3. The system of claim 1, wherein the transaction is at least one of a telephone based, mobile-phone based, and internet based.

4. The system of claim 1, wherein at least part of the cue profile database is configured by dial-in profiling.

5. The system of claim 1, wherein at least part of the cue profile is provided by the queuing party.

6. The system of claim 1, wherein the device comprises, in combination, at least one of an audio processing system, a speech recognition engine, an audio pattern matching component and a cue processor component.

7. The system of claim 6, further comprising an audio playback component adapted for playing pre-recorded audio used to perform a verbal challenge to detect a live person.

8. The system of claim 1, wherein the system is adapted to update the cue profile database after at least one of a certain period and a change in the cue profile.

9. The system of claim 1, wherein the system is further adapted to use a verbal challenge to determine the hold status.

10. A method comprising using a preexisting cue profile for detecting a hold status in a call between a waiting party and a queuing party.

11. A method for detecting a hold status in a transaction between a waiting party and a queuing party, said method comprising using a preexisting cue profile database containing cue profile for at least one queuing party.

12. The method of claim 11, wherein the cue profile of the queuing party comprises at least one of audio cues, text cues, and cue metadata.

13. The method of claim 11, wherein the transaction is at least one of a telephone based, mobile-phone based, and internet based.

14. The method of claim 11, wherein at least part of the cue profile database is configured by dial-in profiling.

15. The method of claim 11, wherein at least part of the cue profile is provided by the queuing party.

16. The method of claim 11, wherein the method comprises, in combination, at least one of audio processing, speech recognition, audio pattern matching, and cue processing.

17. The method of claim 16, further comprising playing pre-recorded audio used to perform a verbal challenge to detect a live person.

18. The method of claim 11, wherein the method updates the cue profile database after at least one of a certain period and a change in the cue profile.

19. The method of claim 11, wherein the method is further adapted to use a verbal challenge to determine the hold status.
